(19) United States
(12) Patent Application Publication
(10) Pub. No.: US 2020/0060462 A1
(43) Pub. Date: Feb. 27, 2020

(54) BEVERAGE MAKING APPARATUS

(71) Applicant: Hongjiang Liu, Shenzhen (CN)

(72) Inventor: Hongjiang Liu, Shenzhen (CN)

(21) Appl. No.: 16/109,632

(22) Filed: Aug. 22, 2018

(51) Int. Cl. A47J 31/20

(52) U.S. Cl. CPC A47J 31/20

(57) ABSTRACT

A beverage making apparatus to automatically separate debris and liquid comprises a main body, an inner cylinder and a base. The base has a shaft and a filter, and the shaft has a plunger. A sealing unit is arranged at the periphery of the plunger, and the periphery of the sealing unit has a sealing ring. A spring is disposed at the base and an upper portion of the plunger, and a nut cover is provided at a top portion of the shaft. In one embodiment, the bottom portion of the main body has a non-slip rubber. In another embodiment, an opening of the inner cylinder has an upper sealing unit. In a further embodiment, a lateral bottom portion of the inner cylinder has a lower sealing unit.

### FIELD OF THE INVENTION

The present invention relates to a beverage making apparatus, and more particularly to a French-pressed style beverage making apparatus to separate liquid and non-liquid objects.

### BACKGROUND OF THE INVENTION

A “French press” bottle, called a “French filter press” bottle as its full name, is an old coffee brewing apparatus, which soaks the coffee powders in the liquid to enable the coffee powders to release the essence of the coffee, so the coffee is relatively rich and strong in taste and is loved by people. Also, the structure of the French press bottle is simple and easy to use, it is still used today and more people use it to brew tea drinks.

Currently, after the coffee is brewed in French press bottles, brewed coffee liquid cannot be automatically and completely isolated from coffee grounds, so the coffee may taste differently after being soaked with the coffee grounds together for a certain period of time. The filtering effect can also be improved in current French press bottles. Therefore, there remains a need for a new and improved French press bottle to overcome the problems stated above.

### SUMMARY OF THE INVENTION

The main objective of the present invention is to provide a beverage making apparatus that can be used to automatically and completely separate the liquid and debris after coffee or tea drinks are brewed, so the brewed coffee or tea may taste differently after soaking together with the coffee grounds or tea leaves for a certain period of time.

In order to accomplish the objective, the beverage making apparatus to automatically separate debris and liquid comprises a main body, an inner cylinder and a base. The base has a shaft and a filter, and the shaft has a plunger. A sealing unit is arranged at the periphery of the plunger, and the periphery of the sealing unit has a sealing ring. A spring is disposed at the base and an upper portion of the plunger, and a nut cover is provided at a top portion of the shaft.

In one embodiment, the bottom portion of the main body has a non-slip rubber. In another embodiment, an opening of the inner cylinder has an upper sealing unit. In a further embodiment, a lateral bottom portion of the inner cylinder has a lower sealing unit.

Comparing with prior arts, the present invention is advantageous because the beverage making apparatus in the present invention can automatically and completely separate the debris and liquid. More specifically, when the inner cylinder is pressed down, tea leaves or coffee grounds can be effectively separated from the tea or coffee. Also, when the inner cylinder is pressed down, the sealing unit on the plunger and the sealing ring are automatically separated to enable the filtered liquid to flow into the inner cylinder. When the user stops to press down the inner cylinder or the inner cylinder is pressed to the bottom of the bottle, the resilience force of the spring is configured to press the sealing unit and sealing ring to completely separate the coffee grounds for example in Zone D with the coffee in Zone C so the taste of the coffee will not be changed due to soaking together with the coffee grounds for a long period of time. On the other hand, when an upward force is applied to pull up the inner cylinder, a negative force is formed against the upward force. When the upward force continues to apply, the sealing unit and the sealing ring can be separated automatically and the liquid and air in Zone C can flow back to Zone D due to the negative pressure so the inner cylinder can be taken out easily.

### BRIEF DESCRIPTION OF THE DRAWINGS

FIG. 1 is a sectional view of the beverage making apparatus in one embodiment in the present invention.

FIG. 2 illustrates a schematic view of the beverage making apparatus in one embodiment in the present invention.

FIG. 3 illustrates a schematic view of the beverage making apparatus with the non-slip rubber in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

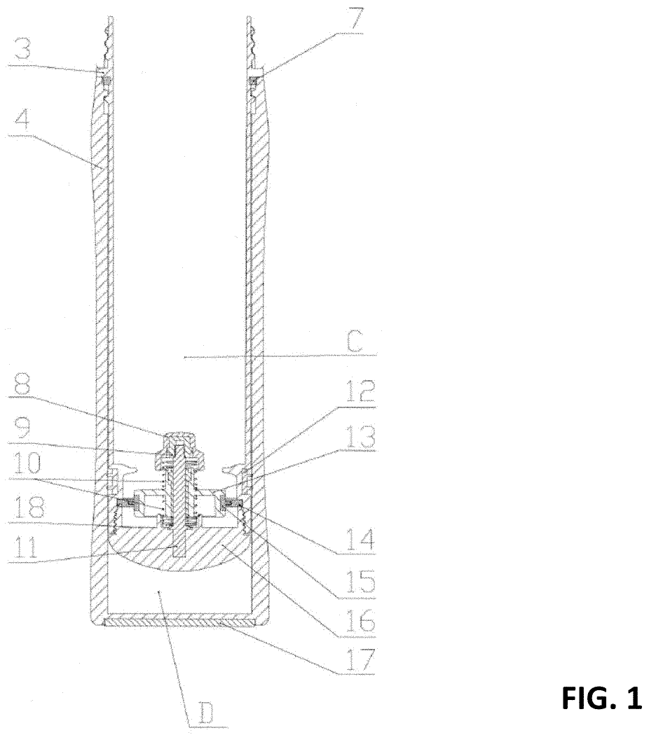

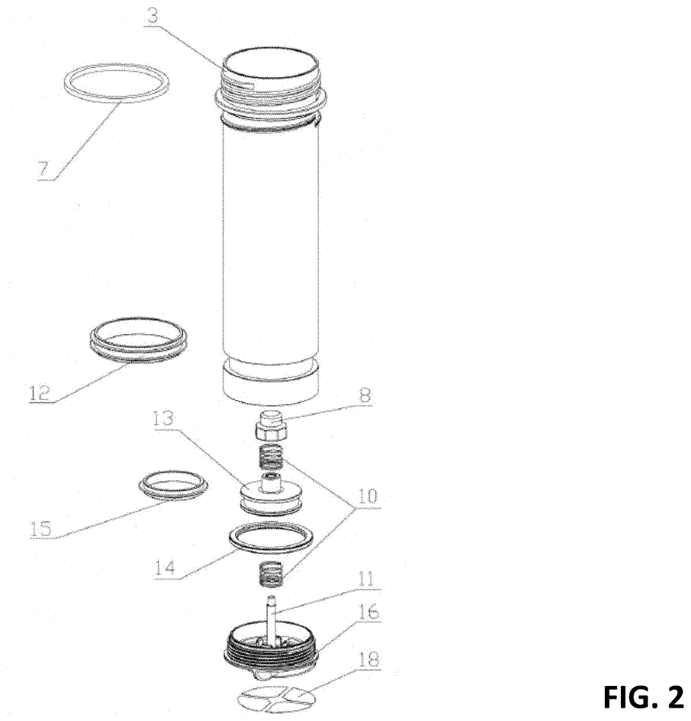

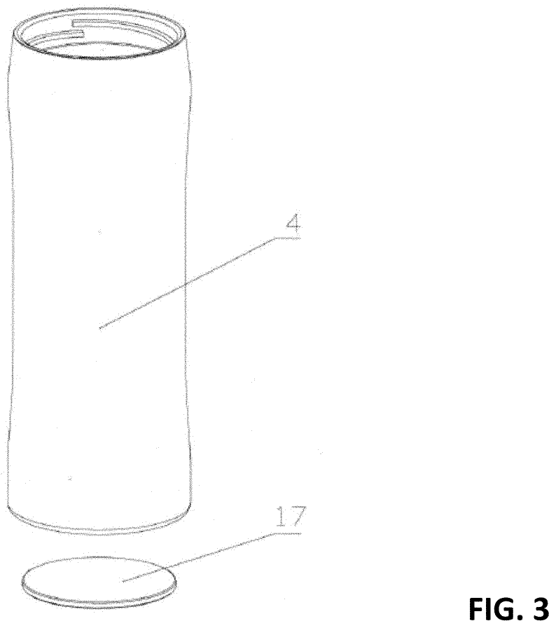

In one aspect, as shown in FIGS. 1 to 3, a beverage making apparatus to automatically separate debris and liquid may include a main body 4, an inner cylinder 3 and a base 16. The base has a shaft 11 and a filter 18, and the shaft has a plunger 13. A sealing unit 15 is arranged at the periphery of the plunger 13, and the periphery of the sealing unit 15 has a sealing ring 14. A spring 10 is disposed at the base 16 and an upper portion of the plunger 13.

In one embodiment, the beverage making apparatus in the present invention is a “French press” beverage marking apparatus. In another embodiment, the bottom portion of the main body 4 has a non-slip rubber 17. In still another embodiment, an opening of the inner cylinder 3 has an upper sealing unit 17 to prevent the liquid from flowing out therefrom. In a further embodiment, a lateral bottom portion of the inner cylinder 3 has a lower sealing unit 12 to prevent the liquid and debris from flowing out from the inner cylinder 3 and the main body 4. In still a further embodiment, a top portion of the shaft 11 has a nut cover 8.

Comparing with prior arts, the present invention is advantageous because the beverage making apparatus in the present invention can automatically and completely separate the debris and liquid. More specifically, when the inner cylinder 3 is pressed down, tea leaves or coffee grounds can be effectively separated from the tea or coffee. Also, when the inner cylinder 3 is pressed down, the sealing unit 15 on the plunger 13 and the sealing ring 14 are automatically separated to enable the filtered liquid to flow into the inner cylinder 3. When the user stops to press down the inner cylinder 3 or the inner cylinder 3 is pressed to the bottom of the bottle, the resilience force of the spring 10 is configured to press the sealing unit 15 and sealing ring 14 to completely separate the coffee grounds for example in Zone D with the coffee in Zone C so the taste of the coffee will not be changed due to soaking together with the coffee grounds for a long period of time. On the other hand, when an upward force is applied to pull up the inner cylinder 3, a negative force is formed against the upward force. When the upward force continues to apply, the sealing unit 15 and the sealing ring 14 can be separated automatically and the liquid and air in Zone C can flow back to Zone D due to the negative force so the inner cylinder 3 can be taken out easily.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A beverage making apparatus comprising a main body, an inner cylinder and a base; the base having a shaft and a filter, and the shaft having a plunger; a sealing unit arranged at a periphery of the plunger, and a periphery of the sealing unit having a sealing ring; a spring disposed at the base and an upper portion of the plunger.

2. The beverage making apparatus of claim 1, wherein a bottom portion of the main body has a non-slip rubber.

3. The beverage making apparatus of claim 1, wherein an opening of the inner cylinder has an upper sealing unit to prevent the liquid from flowing out therefrom.

4. The beverage making apparatus of claim 1, wherein a lateral bottom portion of the inner cylinder has a lower sealing unit to prevent the liquid and debris from flowing out from the inner cylinder and the main body.

5. The beverage making apparatus of claim 1, wherein a top portion of the shaft has a nut cover.
